(19) United States
(12) Patent Application Publication
(10) Pub. No.: US 2006/0175853 A1
(43) Pub. Date: Aug. 10, 2006

(54) Tweezer

(76) Inventors: Paul M. Anderson, Lincroft, NJ (US); Lisa F. Baumgarten, New York, NY (US); Antonette Bivona, Bayside, NY (US); John D. Butcher, Scotch Plains, NJ (US); Ingrid Yung-I Chen, New York, NY (US); Emily M. Cohen, New York, NY (US); Jeffery F. Feng, St. Louis, MO (US); Stacey Leigh Grabiner, Westfield, NJ (US); David D. Kusch, St. Louis, MO (US); Jayne H. Lynch, St. Louis, MO (US); Bryce G. Rutter, St. Louis, MO (US); Heather S. Sopczynski, New York, NY (US)

Correspondence Address: Julie Blackburn;Revlon Consumer Products Corporation, 237 Park Avenue, New York, NY, 10017, US

(21) Appl. No.: 11/053,615

(22) Filed: Feb. 8, 2005

(51) Int. Cl. B25B 9/02

(52) U.S. Cl. 294/99.2

(57) ABSTRACT

A tweezer comprised of arms diverging from a base, wherein each arm has a first section closest to the base that diverges from a straight line perpendicular to the base, and a second section furthest from the base that converges toward a straight line perpendicular to the base.

### TECHNICAL FIELD

The invention is in the field of hair removal devices such as tweezers.

### BACKGROUND OF THE INVENTION

Tweezers are used for a variety of purposes, including hair removal, or for medical purposes such as sliver removal. The typical tweezer has diverging arms with pointed tips. When the arms are compressed by the user, the tips converge and can be used to grip very small items such as hairs, slivers, and the like, and extract them. However, one common problem with the typical tweezer designs is that they can be difficult to grip and manipulate. Tweezer manufacturers have tried to address these difficulties by developing various types of ergnomic designs that facilitate easier gripping and manipulation. For example, U.S. Design Pat. No. 327,751 is directed to an ergonomic tweezer design having hollowed out sections on the upper arms in the area where the user grips the tweezer. U.S. Design Pat. No. 483,909 is directed to another type of ergonomic tweezer having widened portions on each arm. The user grips the widened portions with fingers for easier manipulation of the tweezer. However, in both cases the arms of the tweezers diverge in the usual manner. While the ergonomic portion facilitates gripping, the tweezer arms are in the standard configuration and do not do anything to facilitate grip.

Acccordingly, there is a need for a tweezer design that has ergonomic features both in the gripping portions and in the design of the tweezer arms.

It is an object of the invention to provide a tweezer with ergonomic handle grips.

It is a further object of the invention to provide a tweezer with tweezer arms that are designed so that they can be more easily gripped and manipulated by the user.

It is a further object of the invention to provide an ergonomically designed tweezer that is easily handled and manipulated by the user, with reduced chance of dropping.

### BRIEF DESCRIPTION OF THE DRAWINGS

FIG. 1: depicts the tweezer of the invention being used in the typical manner to remove stray hairs from the eyebrows.

FIG. 2: depicts a side view of the tweezer.

FIG. 3: is a cross sectional view taken across 3-3 of FIG. 2, showing how the arms diverge, then converge from a line perpendicular to the base.

FIG. 4: depicts a standard prior art tweezer showing how arms typically diverge from the base.

### DETAILED DESCRIPTION OF THE DRAWINGS

FIG. 2 is a side view of the tweezer 1 of the invention, having base 2 from which arms 3 diverge. Arms 3 have at least two sections. The first section 4 diverges from straight (broken) line 5 that is perpendicular to the base 2 with a point beginning at the junction 2A between arms 3. The second section 5A furthest from the base 2 converges toward straight line 5. Preferably first section 4 diverges from line 5 at an angle ranging from 1 to 45 degrees, more preferably about 5 to 30 degrees. Preferably second section 5A converges toward line 5 at an angle ranging from 1 to 45 degrees, more preferably from about 1 to 25 degrees.

In the most preferred embodiment of the invention 1 first section 4 is about one half the length of arm 3 and the second section 5A is about one half the length of arm 3. First section 4 may range from about one third to two thirds of the length of arm 3, and second section 5A may range from about one third to two thirds of the length of arm 3.

Second section 5A contains finger grip depressions 6. Preferably finger grip depressions 6 are in the shape of a truncated loop 7 with edge 8 bordering the slanted tip 9. Truncated loop 7 has a rounded edge 10, which preferably extends to midsection 11 of tweezer arms 3. If desired, the finger grip depressions 6 may contain one or more protrusions 12 that further facilitate gripping the tweezer 1. Most preferably each finger grip depression 6 contains at least three protrusions 12.

In one alternative embodiment of the invention, finger grip depression 6 may be over layered with a thin rubber layer 13 that further facilitates gripping. Rubber layer 13 may be slit to accommodate protrusions 12.

Tweezer 1 preferably has a slanted tip 9. The slanted tip 9 may be slanted at an angle ranging from about 1 to 90, preferably 5 to 50, more preferably about 7 to 40 degrees.

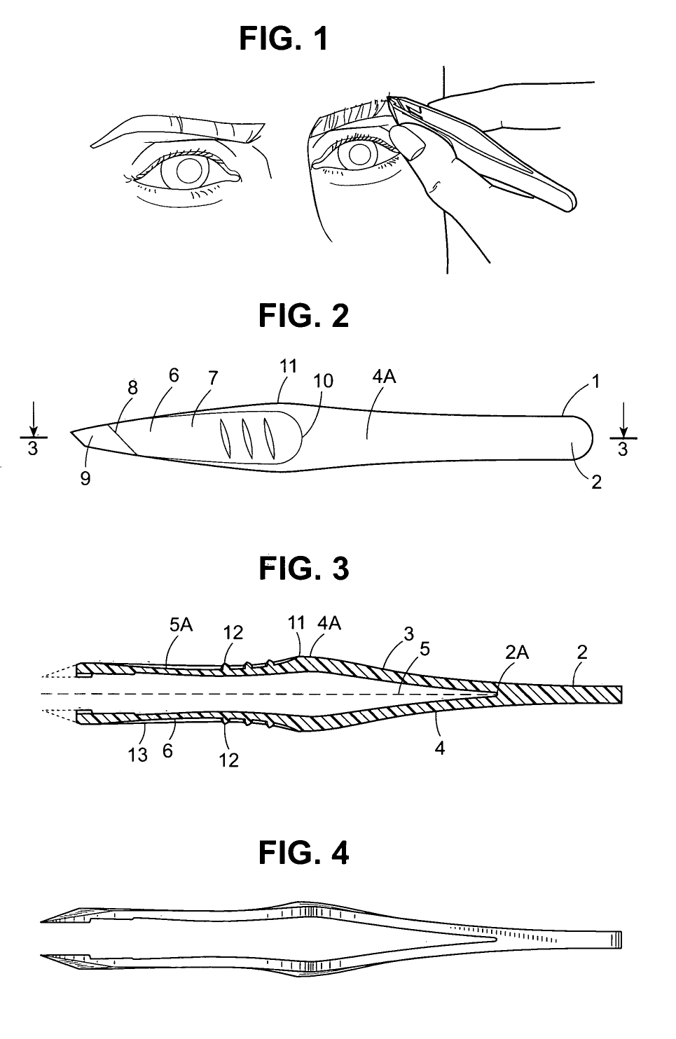

FIG. 1 depicts the tweezer 1 being used to remove stray hairs from the eyebrows. The user grips tweezer 1 by placing fingers on finger grip depressions 6 and squeezing arms together so that slanted tips 9 converge and grip hair between slanted tips 9 so that it can be removed.

Tweezer 1 may be made from thermoplastic materials that have shape memory, such as polypropylene, polyethylene, styrene, and so on. In addition, tweezer 1 may be made from metals that have shape memory, such as tin, aluminum, iron, or alloys of such metals. Preferably the tweezer is made of a thermoplastic material with shape memory, or aluminum.

While the invention has been described in connection with the preferred embodiment, it is not intended to limit the scope of the invention to the particular form set forth but, on the contrary, it is intended to cover such alternatives, modifications, and equivalents as may be included within the spirit and scope of the invention as defined by the appended claims.

1. A tweezer comprised of arms diverging from a base, wherein each arm has a first section closest to the base that diverges from a straight unsloped line that originates at the junction between the arms, and a second section furthest from the base that converges toward the straight unsloped line wherein the second section of at least one tweezer arm has an outer surface having finger grip depressions thereon.

2. The tweezes of claim 1 wherein the first section of the arm diverges from about 1 to 35 degrees from the straight unsloped line.

3. The tweezer of claim 1 wherein the first section of the arm diverges from about 5 to 30 degrees from the straight unsloped line.

4. The tweezer of claim 1 wherein the second section of the arm converges from about 1 to 45 degrees toward the straight unsloped line.

5. The tweezer of claim 1 wherein the second section of the arm converges from about 1 to 25 degrees toward the straight unsloped line.

6. The tweezer of claim 1 wherein the first section is from about one third to two thirds of the total length of the tweezer arm.

7. The tweezer of claim 6 wherein the first section is from about one half the total length of the tweezer arm.

8. The tweezer of claim 1 wherein the second section is from about one third to two thirds the total length of the tweezer arm.

9. The tweezer of claim 1 wherein the second section is about one half the total length of the tweezer arm.

10. The tweezer of claim 1 wherein the outer surface of the second section of at least one arm has a finger grip depression that extends substantially the entire area of the outer surface of second section.

11. The tweezer of claim 10 wherein the second section of both arms have finger grip depressions on the outer surfaces thereof.

12. The tweezer of claim 10 wherein the finger grip depression is in the shape of a truncated loop having a rounded edge bordering finger grip.

13. The tweezer of claim 12 having slanted tips.

14. The tweezer of claim 13 wherein the finger grip depression is in the shape of a truncated loop having a rounded edge bordering finger grip, said truncated loop extending substantially the length of outer surface of second section of tweezer arm.

15. The tweezer of claim 10 wherein said finger grip depressions have protrusions.

16. The tweezer of claim 15 wherein each finger grip depression has from two to three protrusions.

17. The tweezer of claim 1 made from a thermoplastic material.

18. The tweezer of claim 1 made from metal.

19. The tweezer of claim 1 having a tip slanted at an angle of about 25 to 55 degrees.

20. The tweezer of claim 19 having a tip slanted at an angle of about 45 degrees.
